(19) United States
(12) Patent Application Publication
(10) Pub. No.: US 2006/0079202 A1
(43) Pub. Date: Apr. 13, 2006

(54) Method and apparatus to set and retrieve status in communications devices

(75) Inventors: Christopher H. Doan, Austin, TX (US); Brent David Franklin, Round Rock, TX (US); Dustin C. Kirkland, Austin, TX (US); Liliana Orozco, Del Valle, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/960,588

(22) Filed: Oct. 7, 2004

(51) Int. Cl. H04M 3/16

(52) U.S. Cl. 455/411; 455/418

(57) ABSTRACT

A method, apparatus, and computer instructions for identifying a caller status. A status for a selected entry in an electronic phone book in a communications device is retrieved. The status of the selected entry is presented prior to initiating the call for the selected entry in response to a selection of the selected entry for a call by a user.

### BACKGROUND OF THE INVENTION

1. Technical Field

The present invention relates generally to an improved data processing system and in particular to a method and apparatus for processing data. Still more particularly, relates to a method, apparatus, and computer instructions for providing status of entries in an electronic phone book.

2. Description of Related Art

The use of mobile communications devices is widespread. Millions of people all around the world use mobile phones to communicate with each other. Other currently available mobile phones provide a large array of functions and features with new ones being added all the time. For example, a mobile phone may allow a user to store contact information, make tasks or to-do lists, track appointments, set reminders, send and receive email, play games, and obtain information from the Internet.

One useful feature is an electronic phone book. This electronic phone book allows a user to store phone numbers of people that the user desires to call. These electronic phone books allow a user to easily find phone numbers for other users. For example, when a user receives a call, the user may store the number for that call in association with a name. Further, a similar feature is present for phone numbers entered by the user. These electronic phone books also allow multiple phone numbers to be associated with a particular person. For example, an entry in the electronic phone book may include, an office phone number, a home phone number, and a mobile phone number for a particular person.

With all of these features, the present invention recognizes that time is still wasted when a user attempts to reach someone only to find out that the called person is unavailable. The current process involves identifying a name in the electronic phone book and selecting that name. That person can then be called. Typically, the user will hear the phone ring and subsequently, a voice mail message, stating that the called person cannot answer the phone. With the busy schedules and numerous activities that most users are involved in, these steps use up valuable time.

Therefore, it would be advantageous to have an improved method, apparatus, and computer instructions for identifying the availability prior to making the actual phone call.

### SUMMARY OF THE INVENTION

The present invention provides a method, apparatus, and computer instructions for identifying a caller status. A status for a selected entry in an electronic phone book in a communications device is retrieved. The status of the selected entry is presented prior to initiating the call for the selected entry in response to a selection of the selected entry for a call by a user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a communications system in which the present invention may be implemented;

FIG. 2 is a block diagram of a data processing system that may be implemented as a server in accordance with a preferred embodiment of the present invention;

FIG. 3 is a block diagram of a camera phone in accordance with a preferred embodiment of the present invention;

FIG. 4 is a diagram illustrating components used in automatically obtaining status information for entries in an electronic phone book in accordance with a preferred embodiment of the present invention;

FIG. 5 is a diagram of components in a communications device used for providing status information in accordance with a preferred embodiment of the present invention;

FIG. 6 is a table illustrating profiles and status information in accordance with a preferred embodiment of the present invention;

FIG. 7 is a flowchart of a process for transmitting status information in accordance with a preferred embodiment of the present invention;

FIG. 8 is a flowchart of a process for obtaining status information in accordance with a preferred embodiment of the present invention;

FIG. 9 is a flowchart of a process for presenting status information in accordance with a preferred embodiment of the present invention; and

FIG. 10 is a flowchart of an alert process in accordance with a preferred embodiment of the present invention.

### DETAILED DESCRIPTION OF THE PREFERRED EMBODIMENT

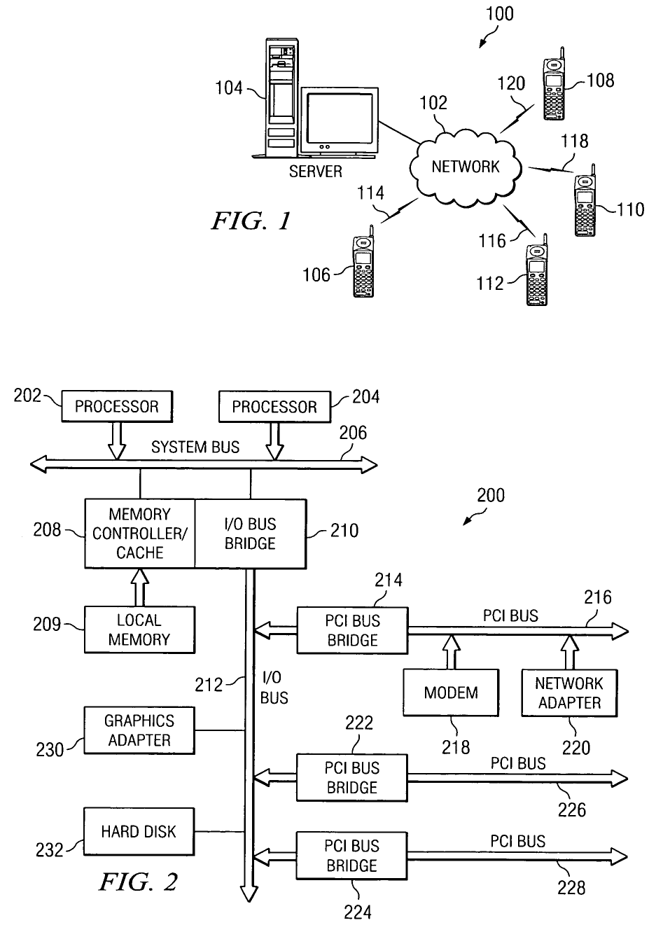

With reference now to the figures, FIG. 1 depicts a pictorial representation of a communications system in which the present invention may be implemented. Communications system 100 is a network of computers and communications devices in which the present invention may be implemented. Communications system 100 contains a network 102, which is the medium used to provide communications links between various devices and computers connected together within communications system 100. Network 102 may include connections, such as wire, wireless communication links, or fiber optic cables. Specifically, network 102 includes wireless communications links for providing voice and data transmissions to mobile devices, such as mobile phones and person digital assistance.

In the depicted example, server 104 is connected to network 102. Server 104 may provide various services for communications devices, such as mobile phones 106, 108, 110, and 112. In these illustrative examples, mobile phones 106, 108, 110, and 112 transfer data, such as voice through wireless communications links 114, 116, 118, and 120. Network data processing system 100 may include additional servers, clients, and other communications devices not shown. FIG. 1 is intended as an example, and not as an architectural limitation for the present invention.

The present invention provides a method, apparatus, and computer instructions for allowing identification of the status of different communications devices within communication system 100. This mechanism allows a user to determine the status of a person that is to be called prior to the call being made to that person.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system. FIG. 2 is a block diagram of a camera phone in accordance with a preferred embodiment of the present invention.

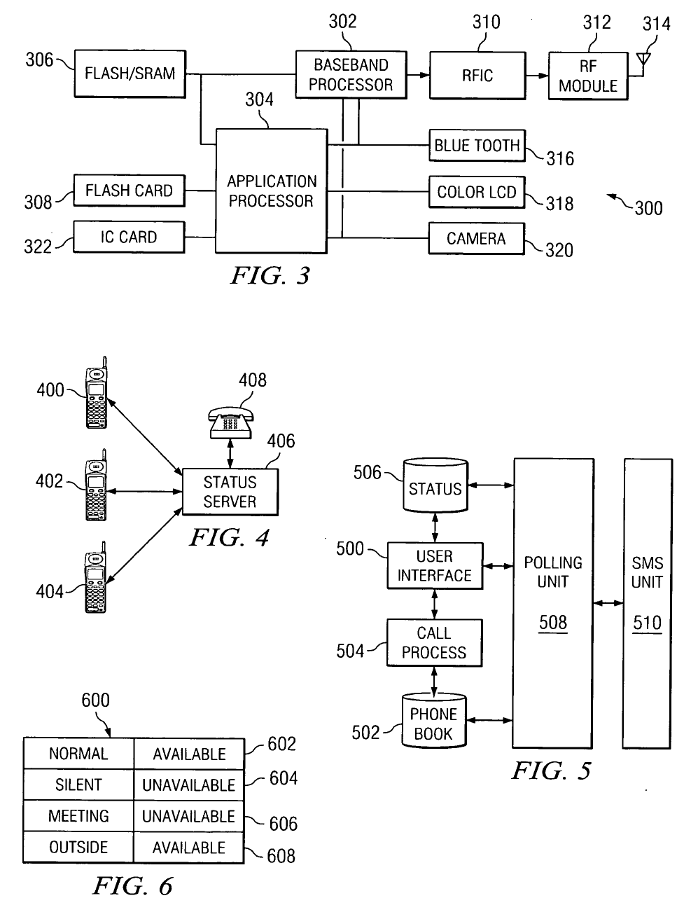

Turning next to FIG. 3, a block diagram of a camera phone is depicted in accordance with a preferred embodiment of the present invention. Camera phone 300 includes baseband processor 302, application processor 304, flash/static random access memory (SRAM) 306, flash card 308, radio frequency integrated circuit (RFIC) 310, radio frequency (RF) module 312, antenna 314, Blue Tooth unit 316, color liquid crystal display (LCD) 318, camera 320, and IC card 322.

Baseband processor 302 provides for receiver and transmitter operations and is also referred to as a transceiver. In particular, baseband processor 302 handles all of the audio, signal, and data processing needed to receive and send data using RF transmissions or Blue Tooth transmissions. Application processor 304 provides the processing power for other functions within camera phone 300. For example, calculators, calendars, alarms, camera functions, and directories are provided through application processor 304. Flash/SRAM 306 is a storage device in which various instructions for providing the functions within camera phone 300 are located and provide upgrades. Flash card 308 is a storage device in which user data and applications may be stored. An example of flash card 308 is a secure digital card.

A pathway for the transmission of voice and other types of data is through RFIC 310. Additionally, short-range transmissions may be sent or received through Blue Tooth unit 316. Blue Tooth unit 316 conforms to Blue Tooth wireless specification, which defines the link layer and application layer for product developers. Both of these transmissions are made through antenna 314 in this illustrative example.

Color LCD 318 provides a display for pictures and other data for camera phone 300. Camera 320, in this example, is a complementary metal oxide semiconductor (CMOS) camera which may be built into camera phone 300 or connected to camera phone 300 as a module, such as IC card 322. IC card 322 also may contain other application specific functions, such as a global positioning system (GPS) or other functions, such as a modem or additional memory.

Camera 320 forms the camera module of camera phone 300, while the other components form the digital phone module of camera phone 300 in these illustrative examples. Instructions or circuits are added to camera phone 300 to provide an electronic phone book and a mechanism for identifying the status of different entries in the electronic phone book.

The present invention provides, a method, apparatus, and computer instructions for identifying the status of one or more entries in an electronic phone book for a communications device.

With reference now to FIG. 4, a diagram illustrating components used in automatically obtaining status information for entries in an electronic phone book is depicted in accordance with a preferred embodiment of the present invention. In this illustrative example, mobile phones 400, 402, and 404 may obtain information about the status of other communications devices through status server 406. Additionally, landline phone 408 also may obtain status information from status server 406. The mechanism of the present invention is applicable to any communications device having an electronic phone book for calling other communications devices.

In this illustrative example, mobile phones 400, 402, and 404 may be implemented using a mobile phone, such as camera phone 300 in FIG. 3. Landline telephone 408 may be implemented using a similar design without a wireless interface. Status server 406 may be implemented using a data processing system, such as data processing system 200 in FIG. 2. In these depicted examples, mobile phones 400, 402, and 404 and landline telephone 408 are communications devices that provide status information to status server 406. This status information may then be provided to other communications devices. Each of the communications devices may poll status server 406 and request status information regarding entries in their electronic phone books.

In these examples, the status information may be publicly available to anyone who requests the information or restrictions may be placed upon the status information as to what users may be allowed to retrieve the information. Additionally, the status may be set differently for selected users. For example, if the user of a mobile phone sets the status to unavailable, the phone status may always be available for a selected user, such as the spouse of the user of the mobile phone.

Users of the communications devices log on and establish a status with server 406. After logging on, the different communications devices may download status information for entries in an electronic phone book. Alternatively, a protocol may be established for exchanged information directly between the communications devices.

When a user at mobile phone 400 selects an entry for a person to be called, the status of that callee may be identified prior to the call being initiated. This status information may be requested when the entry is selected or the information may be previously requested as part of an automatic polling mechanism in mobile phone 400. For example, a user of mobile phone 400 is on the way to a meeting for which the user will be unavailable to answer the phone. The user at mobile phone 400 sets the status to unavailable. This change in status is sent to status server 406. Another user at mobile phone 402 has the number of the user at mobile phone 400 in an electronic phone book. This particular entry has been selected to be polled for status information. The user at mobile phone 402 has a need to call the user at mobile phone 400 and looks for the user of mobile phone 400 in the electronic phone book. The user at mobile phone 402 sees that the status for the user at mobile phone 400 is unavailable. The user at mobile phone 402 decides not to call the user at mobile phone 400 at that time and configures mobile phone 402 to provide an indication of when the status changes. When the user at mobile phone 400 changes the status, this change is provided in an alert to the user at mobile phone 402, who may then call the user at mobile phone 400.

The depicted example in FIG. 4 shows status information being managed in a central location by status server 406. Of course, the status information may be exchanged in other ways. For example, the communications devices may directly exchange status information with each other.

With reference now to FIG. 5, a diagram of components in a communications device used for providing status information is depicted in accordance with a preferred embodiment of the present invention. In this example, user interface 500 provides a display and mechanism for receiving user input from a user. User interface 500 may include processes for selecting information and preferences for accessing data in the communications device. The user may access phone book 502 to select an entry of a person to be called. Call process 504 is employed to initiate the call.

With the mechanism of the present invention, status information may be obtained from status 506 to determine whether the callee in the selected entry from phone book 502 is available. In these examples, the status information is stored in a memory in the communications device. Alternatively, the status information may be stored with an entry in phone book 502. This status information may be presented to the caller through user interface 500. In this manner, the caller may determine the status of the callee prior to initiating a call to the callee.

The status information in phone book 502 is polled and stored for each entry at regular intervals in the illustrative embodiments. The polling or requesting of status information is performed through polling unit 508. Polling unit 508 may periodically poll or request status information for one or more entries in phone book 502. The polling may occur periodically or based on an event. The event may be, for example, a command such as selection of an entry in phone book 502.

This information may be requested through various mechanisms. In the illustrative examples, short message service (SMS) is used to obtain the status information. In these examples, SMS unit 510 requests and receives information in response to commands or signals from polling unit 508. SMS is the transmission of short text messages to and from a mobile phone, fax machine and/or IP address. These messages must be no longer than 160 alpha-numeric characters and contain no images or graphics. When a message using the protocol is sent, it is received by a short message service center (SMSC), the message is sent to the appropriate mobile device. Of course, other mechanisms may be used to obtain status information. For example, current protocols for transferring voice data may be modified to include status information. Polling unit 508 and SMS unit 510 also are used to transmit status information from the mobile phone to other users.

A user may enter a status change through user interface 500. The status may be entered directly or through other user input, such as a user selecting a new profile for the mobile phone. One advantage with directly entering status information the user may provide an indication as to how long the status may remain. For example, the status may be unavailable until after 1:00 p.m. Additionally, the status may be set based on a schedule in which the status changes depending on the time of day. For example, the status may be set as follows: unavailable-sleeping from 10:00 p.m.-5:00 a.m., available from 5:00 a.m.-11:00 a.m., and unavailable-lunch from 11:00 a.m.-12:00 p.m. The status may be stored within the communications device until requested or may be stored in an external database, such as status server 406 in FIG. 4.

The status information also may indicate preferences for calling a user. For example, a user may have a mobile phone number, a home phone number, or a work phone number. Although the user may be available at the work phone number, the user may include a preference to be called at another, such as the home number. The status message displayed may read “Available, call home number first”. Of course, many other types of messages may be included in the status information for different preferences of a user.

This status change is transmitted to other users through SMS unit 510. This status information may be transmitted in different ways. For example, the status information may be transmitted to a server or directly to other mobile devices depending on the particular implementation. Additionally, polling unit 508 also may be used to provide alerts when changes in the status of a selected entry in phone book 502 occurs. When a user selects an entry from phone book 502, status information for that entry is retrieved.

These components illustrated in FIG. 5 may be implemented using software, hardware, or a combination of the two located in a mobile phone, such as camera phone 300 in FIG. 3. These components have been illustrated for purposes of describing the invention and the processes may be implemented.

Turning next to FIG. 6, a table illustrating profiles and status information is depicted in accordance with a preferred embodiment of the present invention. Table 600 includes entry 602, 604, 606, and 608. In these examples, profiles define different modes of operation for a mobile phone. Different profiles may have, for example, different ring tones and different volumes for ring tones. For example, an outside profile may have a loud ring tone, while a medium ring tone may only provide for a single low level beep. Depending on the profile being used, a user may wish to be available or unavailable for calls.

Entry 602 contains a normal profile in which the status is available, entry 604 contains a silent profile in which the status is unavailable, entry 606 contains a meeting profile in which the status is unavailable, and entry 608 contains an outside profile in which the status is available. In this example, status information as to the availability of a user is sent in response to a profile change for the mobile phone selected by a user.

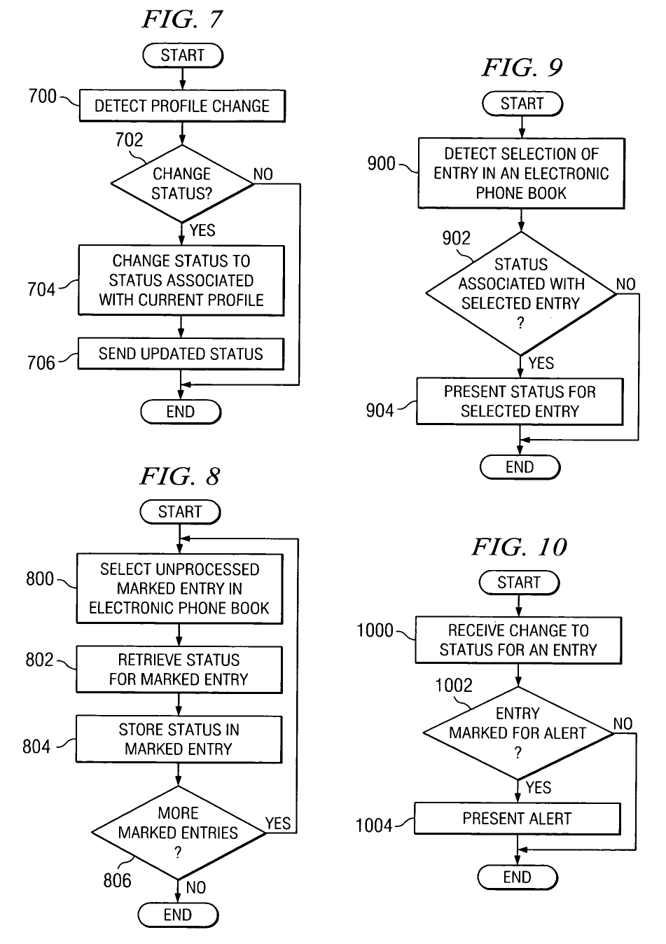

Turning next to FIG. 7, a flowchart of a process for transmitting status information is depicted in accordance with a preferred embodiment of the present invention. The process illustrated in FIG. 7, may be implemented in a mobile phone process, such as polling unit 508 in FIG. 5. This process may be used when status information is not directly entered by the user.

The process begins by detecting whether a profile change has occurred (step 700). If profile change has not occurred, the process returns to step 700. With reference again to step 700, if a profile change has occurred, a determination is made as to whether the status of the user has changed (step 702). This determination may be made using a table, such as table 600 in FIG. 6.

If the status has changed, the status is changed to the status associated with the current profile (step 704). The updated status is then sent (step 706) with the process terminating thereafter. With reference again to step 702, if the status has not changed, the process terminates.

With reference next to FIG. 8, a flowchart of a process for obtaining status information is depicted in accordance with a preferred embodiment of the present invention. The process illustrated in FIG. 8 may be implemented in a process, such as polling unit in FIG. 5. With this mechanism, status information may be retrieved for everyone in the phone book or only for selected entries.

The process begins by selecting an unprocessed marked entry in the electronic phone book (step 800). Status information for the marked entry is retrieved (step 802). The status information is then stored in the entry (step 804). A determination is then made as to whether additional marked entries are present that have not been processed (step 806). If additional marked entries are present, the process returns to step 800. Otherwise, the process terminates.

With reference next to FIG. 9, a flowchart of a process for presenting status information is depicted in accordance with a preferred embodiment of the present invention. The process illustrated in FIG. 9 is a user interface, such as user interface 500 in FIG. 5 to present status information.

The process begins by detecting the selection of an entry in an electronic phone book (step 900). A determination is made as to whether status information is associated with the selected entry (step 902). If status information is associated with the selected entry, this status is presented (step 904) with the process terminating thereafter. Otherwise, the process terminates.

The status information in these examples may be presented in different ways. For examples, the status may be presented on a display of the communications device as text or a graphical indicator. Alternatively, the status information may be presented audibly to the user through a speaker in the communications device.

With reference now to FIG. 10, a flowchart of an alert process is depicted in accordance with a preferred embodiment of the present invention. The process illustrated in FIG. 10 may be implemented as part of a polling process, such as polling unit 506 in FIG. 5.

The process begins by receiving a change to a status for an entry (step 1000). A determination is made as to whether the entry has been marked for an alert (step 1002). If the entry has been marked for alert, the alert is then presented (step 1004) with the process terminating thereafter. This alert is used to let the user know that the status of a person in the phone book has changed. If the entry has not been marked for an alert, the process terminates.

Thus, the present invention provides an improved method, apparatus, and computer instructions for indicating the status of a user. The mechanism of the present invention allows for status information to be exchanged between communications devices to indicate the status of different users. The status of an entry in an electronic phone book may be displayed to a user prior to initiating a call. In this manner, the user may avoid wasting time and reaching the voice mail of a callee when the user does not wish to leave a message for the callee.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the mechanism of the present invention also may be applied to other types of communication systems. The processes described above may be applied to providing status information for email systems. In this manner, the sender of an email message may be able to determine whether the recipient is available to read the email message before creating and sending the email message. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a communications device for identifying a caller status, the method comprising:
retrieving a status for a selected entry in an electronic phone book; and
responsive to a selection of the selected entry for a call by a user, presenting the status of the selected entry prior to initiating the call for the selected entry.

2. The method of claim 1, wherein the retrieving step comprises:
polling for the status of a callee for the selected entry to form a current status; and
updating the selected entry with the current status.

3. The method of claim 2, wherein the polling step is initiated in response to an event.

4. The method of claim 3, wherein the event is a periodic event or a non-periodic event.

5. The method of claim 1, wherein the presenting step comprises:
displaying the status of the selected entry prior to the user initiating the call for the selected entry.

6. The method of claim 1, wherein the presenting step comprises:
audibly presenting the status of the selected entry prior to the user initiating the call for the selected entry.

7. The method of claim 1 further comprising:
receiving a user input indicating a status of the communications device.

8. The method of claim 7 further comprising:
sending the status of the communications device to a server.

9. The method of claim 7, wherein the user input is an entry of the status by the user.

10. The method of claim 7, wherein receiving step includes:
receiving the user input, wherein the user input specifies a profile change to a new profile;
determining whether the new profile requires changing the status of the communications device; and
responsive to a determination that the new profile requires changing the status of the communications device, updating the status of the communications device.

11. A data processing system in a communications device for identifying a caller status, the data processing system comprising:
retrieving means for retrieving a status for a selected entry in an electronic phone book; and
presenting means, responsive to a selection of the selected entry for a call by a user, for presenting the status of the selected entry prior to initiating the call for the selected entry.

12. The data processing system of claim 11, wherein the retrieving means comprises:
polling means for polling the status of a callee for the selected entry to form a current status; and
updating means for updating the selected entry with the current status.

13. The data processing system of claim 12, wherein the polling means is initiated in response to an event.

14. The data processing system of claim 13, wherein the event is a periodic event or a non-periodic event.

15. The data processing system of claim 11, wherein the presenting means comprises:
displaying means for displaying the status of the selected entry prior to the user initiating the call for the selected entry.

16. The data processing system of claim 11, wherein the presenting means comprises:
audibly presenting means for audibly presenting the status of the selected entry prior to the user initiating the call for the selected entry.

17. A computer program product in a computer readable medium in a communications device for identifying a caller status, the computer program product comprising:
first instructions for retrieving a status for a selected entry in an electronic phone book; and
second instructions, responsive to a selection of the selected entry for a call by a user, for presenting the status of the selected entry prior to initiating the call for the selected entry.

18. The computer program product of claim 17, wherein the first instructions comprises:
first sub-instructions for polling for the status of a callee for the selected entry to form a current status; and
second sub-instructions for updating the selected entry with the current status.

19. The computer program product of claim 18, wherein the first sub-instructions is initiated in response to an event.

20. The computer program product of claim 19, wherein the event is a periodic event or a non-periodic event.

21. The computer program product of claim 17, wherein the second instructions comprises:
sub-instructions for displaying the status of the selected entry prior to the user initiating the call for the selected entry.

22. The computer program product of claim 17, wherein the second instructions comprises:
sub-instructions for audibly presenting the status of the selected entry prior to the user initiating the call for the selected entry.

23. The computer program product of claim 17 further comprising:
third instructions for receiving a user input indicating a status of the communications device.

24. The computer program product of claim 23 further comprising:
fourth instructions for sending the status of the communications device to a server.

25. The computer program product of claim 23, wherein the user input is an entry of the status by the user.

26. The computer program product of claim 23, wherein third instructions includes:
first sub-instructions for receiving the user input, wherein the user input specifies a profile change to a new profile;
second sub-instructions for determining whether the new profile requires changing the status of the communications device; and
third sub-instructions, responsive to a determination that the new profile requires changing the status of the communications device, for updating the status of the communications device.

27. A data processing system comprising:
a bus system;
a memory connected to the bus system, wherein the memory includes a set of instructions; and
a processing unit connected to the bus system, wherein the processing unit executes a set of instructions to retrieve a status for a selected entry in an electronic phone book in response to a selection of the selected entry for a call by a user, presenting the status of the selected entry prior to initiating the call for the selected entry.
